(19) United States
(12) Patent Application Publication
(10) Pub. No.: US 2014/0358728 A1
(43) Pub. Date: Dec. 4, 2014

(54) Facilitating Transactions Between Shoppers And Sellers Using Uploaded Content Files

(71) Applicant: Lightning Pic Inc., Saline, MI (US)

(72) Inventor: Srinivasu Ammisetti Sunkara, Erie, PA (US)

(73) Assignee: Lightning Pic Inc.

(21) Appl. No.: 13/909,188

(22) Filed: Jun. 4, 2013

(51) Int. Cl. G06Q 30/06

(52) U.S. Cl. CPC G06Q 30/0613
USPC 705/26.41

(57) ABSTRACT

A server for facilitating transactions between shoppers and sellers using uploaded content files includes anon-transitory storage device, a network interface device, and a processing device that executes a content upload module and a search module. The content upload module is configured to receive an uploaded content file from a first user computing device corresponding to an uploader and associate at least one setter of goods or services with the uploaded content file. The search module is configured to electronically provide one or more content files including the uploaded content file to a second user computing device of a shopper. Each content file has at least one associated seller. The search module is further configured to receive an indication of electronic selection of the uploaded content file and update a selection award associated with the uploaded content file or an uploader of the uploaded content file.

### TECHNICAL FIELD

This disclosure relates to facilitating transactions between shoppers and sellers using uploaded content files.

### BACKGROUND

Content uploading and viewing are two very popular on-line activities. Users have used dedicated content sharing applications and social networking applications to share content with other users. These applications allow users to add content files such as images, photographs, video, and audio, endorse content, comment on content, and/or tag people or places in the content. The foregoing paradigm is entertaining for users, but offers very little economic value.

### SUMMARY

One aspect of the disclosure provides a method that includes receiving an uploaded content file at a processing device and associating, at the processing device, at least one seller of goods or services with the uploaded content file. The method further includes electronically providing, from the processing device, one or more content files including the uploaded content file. At least one content file may be associated with no sellers, one seller, or more than one seller. The method also includes receiving, at the processing device, an indication of electronic selection of the uploaded content file and updating, at the processing device, a selection award associated with the uploaded content file or an uploader of the uploaded content file.

Implementations of the disclosure may include one or more of the following features. In some implementations, the method includes receiving an uploaded content file and linking the uploaded content file to one or more sellers, based on subject matter of the content file. The linking step can be mediated through a special purpose processing device that determines which sellers to link to the content file based on at east one of seller information, user information, content file information or a resource identifier. The uploaded content file may be at least one of a video file, an image file (e.g., a digital photograph), or an audio file. The method may include receiving the uploaded content file from a first user computing device corresponding to the uploader, and receiving the indication of electronic selection from a second user computing device corresponding to a shopper.

According to some implementations of the disclosure, associating the at least one seller includes receiving or obtaining, at the processing device, a resource identifier indicating a website of the seller, e.g., from the uploader, the seller, or other direct/indirect source, and associating, at the processing device, the uploaded content file with the website based on the resource identifier. Further, in some implementations, receiving the content file includes receiving, at the processing device, a description corresponding to the content file from the uploader and receiving, at the processing device, fir each seller, an indicator of the seller from the uploader (or other direct/indirect source). The indicator of the seller may be used to look up the uniform identifier indicating the website of the seller. In some examples, the method includes using a bar code, quick response (QR) code, symbol, or other type of identifier to identify a seller. The method may include determining or identifying one or more sellers based on information associated with or ascertained from the content file, whether by textual analysis, location analysis, content file analysis, or any other information provided by user directly, indirectly, or contextually.

In some implementations, electronically providing the one or more content files includes receiving, at the processing device, search criteria from a user computing device corresponding to a shopper and retrieving, at the processing device, the one or more content files including the uploaded content file based on the search criteria. The one or more content files are retrieved from a plurality of content files (e.g., stored in non-transitory memory or a database). Furthermore, electronically providing the one or more content files may include determining, at the processing device, the resource identifier of the uploaded content file based on the association of the uploaded content file with the resource identifier and providing, from the processing device, the uploaded content file and the resource identifier.

In some implementations, each content file of the plurality of content files has corresponding content file data that includes a set of identifying filter criteria of the shopper. For example, the content file data may identify a category of an associated seller that is associated with the content file. The search criteria may include a category selection of the shopper. In these implementations, retrieving the one or more content files can include identifying content files from the plurality of content files that have content file data indicating a category (e.g., filter category) corresponding to the category selection included in the search criteria.

According to some implementations of the disclosure, receiving the indication of selection includes receiving confirmation that a shopper completed a transaction with the seller. Furthermore, the selection award may be monetary or non-monetary consideration.

The method may be a computer program product encoded on a non-transitory computer readable storage medium including instructions that when executed by a data processing apparatus cause the data processing apparatus to perform operations of the method(s) described above.

Another aspect of the disclosure provides a server that includes a non-transitory storage device, a network interface device, and a processing device that executes a content upload module and a search module. The content upload module is configured to receive an uploaded content file from a first user computing device corresponding to an uploader and associate at least one seller of goods or services with the uploaded content file. The search module is configured to electronically provide one or more content files including the uploaded content file to a second user computing device of a shopper. At least one content file may be associated with no sellers, one seller, or more than one seller. The search module is further configured to receive an indication of electronic selection of the uploaded content file and update a selection award associated with the uploaded content file or an uploader of the uploaded content file.

In some implementations, the content upload module associates the at least one seller with the uploaded content file by obtaining a resource identifier indicating a website of the seller from the uploader (or another source, such as the seller) and associating the uploaded content file with the website based on the resource identifier. The content upload module may be further configured to receive a description corresponding to the content file from the first computing device and receive an indicator of the seller from the first computing device. The indicator of the seller may be used by the search module to look up the resource identifier indicating the website of the seller.

In some implementations, the search module is configured to electronically provide the one or more content files by receiving search criteria from the second user computing device and retrieving the one or more content files including the uploaded content file based on the search criteria. The one or more content files are retrieved from a plurality of content files. In these implementations, the search module may be further configured to determine the resource identifier of the uploaded content file based on the association of the uploaded content file with the resource identifier and providing the uploaded content file and the resource identifier.

According to the some implementations, each content file of the plurality of content files has corresponding content file data that includes a set of identifying filter criteria of the shopper. In some examples, the content file data identifies a category of an associated seller that is associated with the content file and the search criteria may include a category selection of the shopper. In these implementations the search module may be configured to retrieve the one or more content files by identifying content files from the plurality of content files that have content file data indicating a category (e.g., filter category) corresponding to the category selection included in the search criteria.

The search module may receive confirmation that the shopper completed a transaction with the seller after selecting the content file. Moreover, the search module may update the selection award upon receiving the confirmation. In some examples, the selection award is monetary consideration. Additionally, or alternatively, the selection award is points that are awarded to an account of the uploader.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example environment of a content link server.

FIG. 2 is a schematic view of an example set of components of a content link server.

FIG. 3 is a schematic view of an exemplary graphical user interface that allows an uploader to upload content file data.

FIG. 4 is a flow chart illustrating an example set of operations of a method for updating a content link datastore.

FIG. 5 is a flow chart illustrating an example set of operations of a method for facilitating a transaction between a shopper and a seller.

FIG. 6 is a schematic view of an exemplary graphical user interface that allows a user to enter search criteria.

FIGS. 7A-7D are schematic views of an exemplary graphical user interface that allows a user to view and select content files.

FIG. 8 is a schematic view of an exemplary graphical user interface that displays notifications to a user.

FIG. 9 is a schematic view of an exemplary graphical user interface that displays rankings of uploaders and content files to a user.

Like reference symbols in the various drawings indicate like elements.

### DETAILED DESCRIPTION

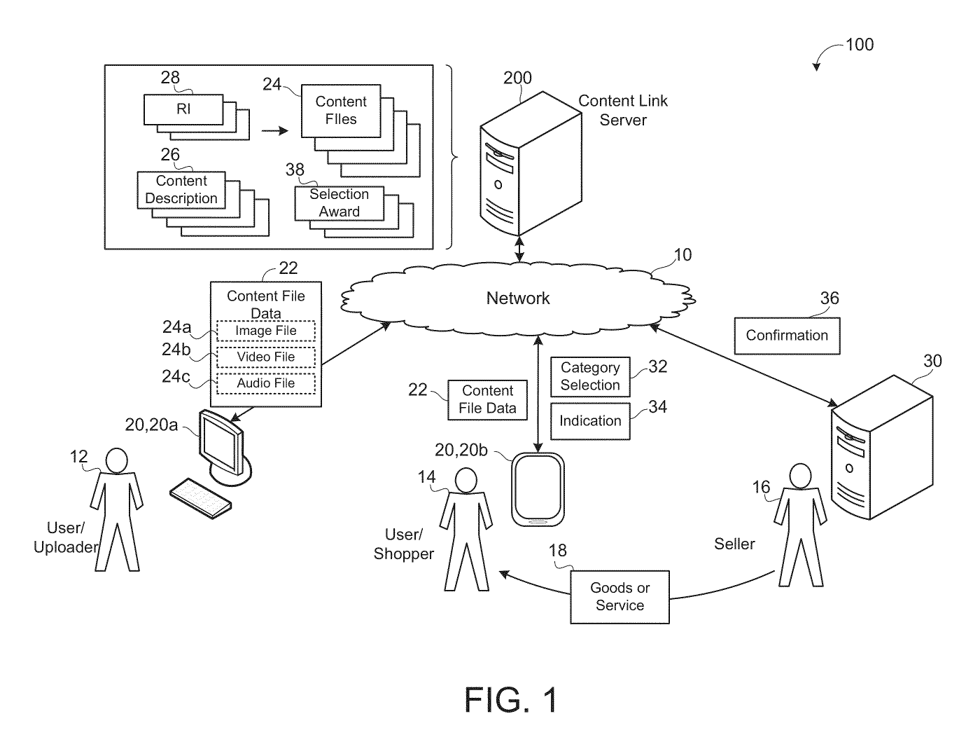

FIG. 1 is a schematic view illustrating an example environment 100 of a content link server 200 that is configured to facilitate transactions between shopper users 14 (referred to as “shoppers”) and sellers 16 based on content file data 22 uploaded by one or more uploading users 12. An uploading user, herein referred to as an “uploader” 12, uploads content file data 22 to the content link server 200 from a user computing device 20a. An uploader 12 can also be a shopper 14. In some implementations, the content file data 22 can include a content file 24, a content description 26 (e.g., including a category of the content file 24, a location, a date-time stamp, a name, and/or other information), and/or one or more resource identifiers 28, each resource identifier 28 corresponding to a website 30 of a seller 16 that sells a good and/or service 18. For instance, an uploader 12 can upload content file data 22 that includes a content file 24 containing an image of a plate of food, a content description 26 that states the name of the restaurant or dish, and a first resource identifier 28 that links to a website 30 of the restaurant 16 and a second resource identifier 28 that links to a website 30 that takes reservations for different restaurants. The content link server 200 associates the content file 24 with the seller 16 by way of the resource identifier 28 corresponding to the seller 16.

The content files 24 contained in the content file data 22 can be one or more of an image file 24a, a video file 24b, and audio file 24c. An image file 24a can include a digital photograph or any other suitable digital image in any suitable format. A video file 24b can include a digital video file in any suitable format. An audio file 24c can include audio sounds, speech, or music in any suitable format. A resource identifier can refer to a data item that can be used to access a remote device over a network. For example, a resource identifier can be a uniform resource locator (URL) or an IP address.

A shopper 14 can access the content link server 200 from a user computing device 20b. In some implementations, the shopper 14 can provide a category selection 32 that indicates a category of goods or services 18 that the shopper 14 wants to view. In response, the content link server 200 provides content file data 22 corresponding to the category selection 32. Put another way, the content link server 200 may provide one or more content files 24, and for each content file 24, a description 26, one or more sellers 16 to associate with the content file 24, and one or more resource identifiers 28 corresponding to the sellers 16. For example, in response to a category selection 32 of “food,” the content link server 200 provides content files 24 that have been tagged with the category “food,” and for each content file 24, can provide one or more resource identifiers 28 that each link to a website of a seller 16 that is somehow related to food. The content files 24 may be presented in a graphical user interface being displayed by the user computing device 20b and/or may be presented via a user interface, such as an audio speaker. The shopper 14 can scroll through the content files 24 and may select one of the content files 24. For example, the shopper 14 can select a content file by clicking or tapping on a particular content file 24 or on a resource identifier 28 that is displayed in relation to the content file 24. In response to the shopper 14 selecting a content file 24, the user computing device 20b, e.g., via a web browser executing thereon, accesses the website 30 of a seller 16 that has been associated with the content file 24 by an uploader 12 or other means, such as a third-party system. Furthermore, the user computing device 20b of the shopper 14 may provide an indication 34 of the selection to the content link server 200. Additionally or alternatively, if the shopper 14 completes a purchase on the website 30, the website 30 may provide a confirmation 36 of the purchase to the content link server 200.

In response to receiving an indication 34 that the shopper 14 selected content file 24, and/or a confirmation 36 that the shopper 14 completed a purchase, the content link server 200 updates a selection award 38 of the uploader 12 who uploaded the selected content file 24. Updating a selection award 38 of the uploader 12 can include, but is not limited to, awarding an account of the uploader 12 with points or providing a monetary reward to the uploader 12.

As used herein, the term user computing device 20 can refer to any computing device with a user interface. Examples of user computing devices 20 can include, but are not limited to, stationary computing devices 20a and mobile computing devices 20b. It is noted that while FIG. 1 illustrates an uploader 12 using a stationary computing device 20a and the shopper 14 using a mobile computing device 20, any user 12, 14 may access the content link server 200 using any suitable user computing device 20. Furthermore, while the content link server 200 is shown as a single computing device, the content link server 200 may be implemented as multiple computing devices working individually or in a distributed manner. In these implementations, the computing devices making up the content link server 200 may be located in the same physical location or may be located at different physical locations. It is further noted that the delineation between uploaders 12 and shoppers 14 is done so for explanatory purposes only. An uploader 12 may act as a shopper 14 and vice-versa.

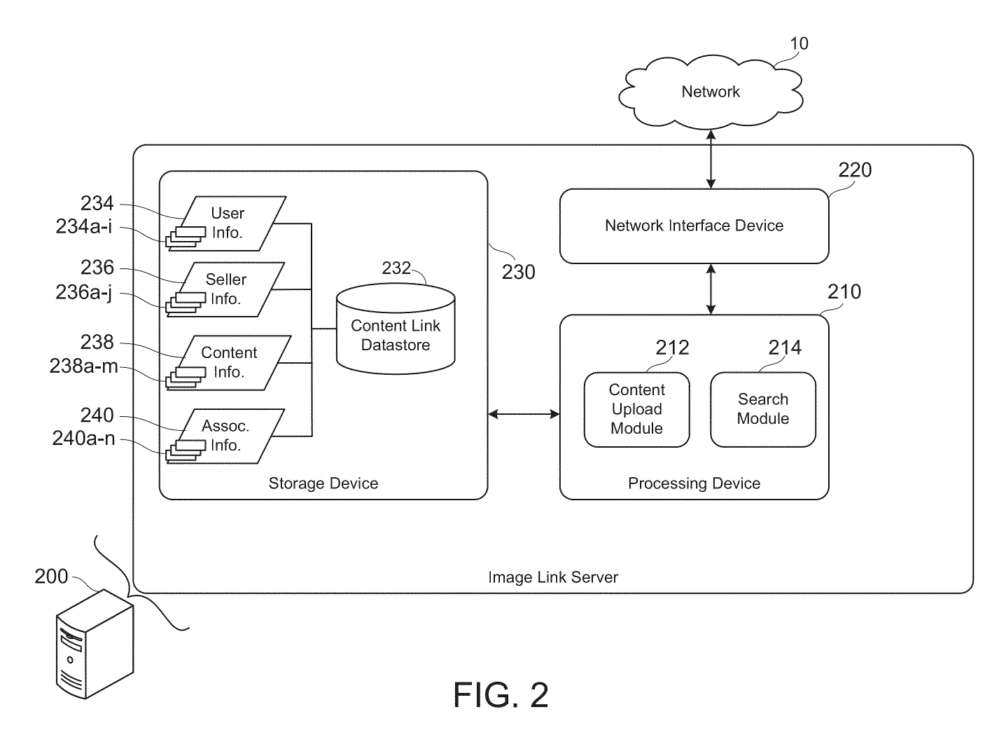

FIG. 2 illustrates a schematic view of an example content link server 200. The content link server 200 is configured to direct shoppers 14 to sellers 16 based on content file data 22 provided by uploaders 12. The content link server 200 is configured to communicate with any number of user computing devices 20 and third-party websites 30. In the illustrated example, the content link server 200 includes a processing device 210, a network interface device 220, and a storage device 230.

The processing device 210 may include one or more processors and one or more non-transitory computer readable mediums storing machine-readable instructions that are executable by the processors. In implementations including two or more processors, the two or more processors can execute in an individual or distributed manner. The processing device 210 can execute a content upload module 212 and a search module 214, both of which may be embodied as machine-readable instructions.

The network interface device 220 performs communication with other remote devices via the network 10. The network interface device 220 can perform wired or wireless communication. Examples of the network interface device 220 include, but are not limited to, a transceiver configured to perform communications using the IEEE 802.11 wireless standard, an Ethernet port, an optical transmitter and receiver, and a universal serial bus (USB) port. While one network interface device 220 is illustrated, the network interface device 220 can include multiple network interface devices 220 configured to perform one or more different types of communication.

The storage device 230 can include one or more nonvolatile non-transitory computer readable mediums. Examples of a storages device include, but are not limited to, hard disk drives, solid state drives, optical disk drives, and flash drives. The storage device 230 may store a content link datastore 232.

The content link datastore 232 can store user information 234, seller information 236, content information 238, and association information 240. The user information 234, seller information 236, content information 238, and association information 240 may be tables, objects, or any other suitable data structure. In some implementations, the content link datastore 232 includes a relational database, such that the different information is implemented as database tables.

The user information 234 may include user records 234a-i corresponding to users 12 of the content link server 200. The fields or values of a user record 234a-i may include, but are not limited to, a user identifier, username, selection awards, and a confirmed purchase history. The user identifier can indicate a numeric, alphanumeric, or character string that uniquely identifies the user 12 from other users 12. The username can indicate a name that the user has selected. The selection award indicates the selection award of the corresponding user 12. The selection award may indicate an amount of points and/or money that have been awarded to the user 12 or any other type of reward that can be given to a user 12. The purchase history of the user 12 may indicate purchases that were made by the user 12 on a third party website 30. The purchase history may indicate the website 30 from which the purchase was made and/or an identifier of a good or service 18 that was purchased by the user 12. A user record 234a-i may include additional or alternative values.

The seller information 236 may include seller records 236a-j respectively corresponding to sellers 16 of goods and services 18. The fields or values of a seller record 236a-j may indicate a seller identifier, a seller name, and/or one or more seller resource identifiers. The seller identifier can be a numeric, alphanumeric, or character string that uniquely identifies the seller 16 from other sellers. The seller name can be a name of the seller 16. The seller resource identifier 28 can be a resource identifier 28 corresponding to the seller's website 30 or other seller information. In some examples, a code identifies an occurrence of an access (e.g., click-through) to a product purchase website of a seller 10 or an affiliate of the seller 16 via the content link server 200. In some examples, the resource identifier 28 is an application specific identifier recognizable by the seller 16, so that identification is multi-directional between the seller 16, the user 12, the shopper 14, and/or the content link server 200. A seller 16 can register with the content link server 200, such that the seller 16 can provide its name and one or more resource identifiers 28 to associate with the setter 16. In this way, a seller 16 can opt in to the framework by which shoppers 14 can be directed to a website of the seller 16. Furthermore, as will be discussed, an uploader 12 can select a seller 16 to associate with a content file, even without knowledge of a resource identifier 28 of the seller's website 30. A seller record 236a-j may include additional or alternative values.

The content information 238 may include content records 238a-m. The fields or values of a content record 238a-m can include a content file identifier, a reference to the content file 24, a description, one or more tags, a click-through history, and a purchase history. The content file identifier can be a numeric, alphanumeric, or character string that uniquely identifies the content file 24 from other content files 24 stored on the device. The reference of to the content file 24 may identify a location in memory where the actual content file 24 may be found. The description can include the description that was included in the content file data 22 by the uploader 12. Each tag can indicate a tag that the uploader 12 applied to the content file 24, including one or more categories to which the content file 24 belongs. It is noted that a tag may be considered a description having a discrete range of values. The click-through history of a content file 24 can indicate the amount of instances that a content file 24 has been selected by a shopper 14. Furthermore, the click-through history may include timestamps that respectively indicate each time a shopper 14 selected the content file 24. The purchase history of a content file 24 may indicate an amount of instances that the selection of the content file 24 resulted in a purchase by a shopper 14, a timestamp, and/or which shoppers 14 selected the content file 24. Furthermore, the purchase history of the content file 24 may include a timestamp corresponding to each purchase. A content record 238a-m may include additional or alternative values.

The association information 240 can include association records 240a-n. An association record 240a-n can indicate an association made by an uploader 12 between a content file 24 and one or more sellers 16. The fields or values of an association record 240a-n may include an association identifier, a content file identifier, a user identifier, and one or more seller identifiers. The association identifier can uniquely identify an association from other associations. The content file identifier can indicate the content file 24 being associated with one or more sellers 16. The user identifier can indicate the uploader 12 that uploaded the content file 24 being associated with the one or more sellers 16. The one or more seller identifiers can respectively indicate setters 16 that have been associated with the content file 24. In some implementations, the association information 240 may further include one or more resource identifiers 28 for each seller 16 listed in the association record 240a-n. An association record 240a-n may include additional or alternative values.

The content upload module 212 receives content file data 22 from a user computing device 20 and stores the content file data 22 in the content link datastore 232. In doing so, the content upload module 212 can associate the content file 24 contained in the content file data 22 with one or more sellers 16 and/or other associations (products or entities). The content upload module 212 may provide instructions to a user computing device 20 for rendering a graphical user interface (GUI) that allows an uploader to upload a content file 24 and to provide additional content file data 22.

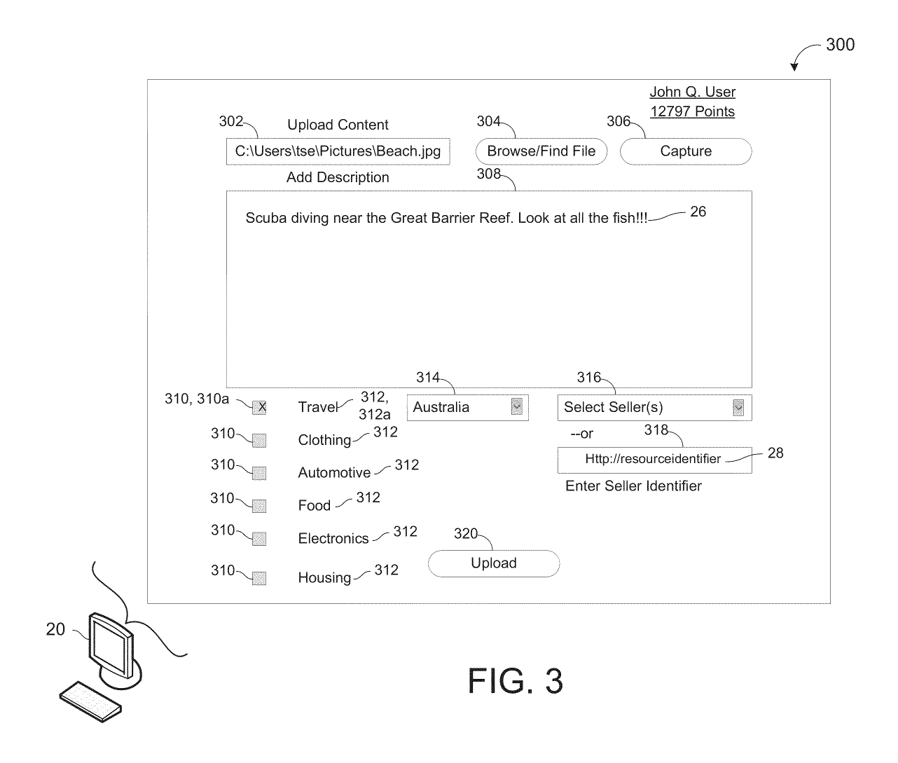

FIG. 3 illustrates an exemplary GUI 300 that allows an uploader 12 to upload content file data 22. In the example shown, the uploader 12 can upload a content file 24 by providing a file path of the content file 24 in a text input object 302. The user 12 can click on the “Browse/Find File” input object 304 to browse various file directories to identify a previously captured content file 24 that is stored in non-transitory memory associated with the user computing device 20 (e.g., the memory of the user computing device 20 or a cloud based storage service). Additionally or alternatively, the GUI 300 may include a “capture” input object 306 that allows an uploader 12 to capture a content file 24 in real-time. This feature may be available when the user computing device 20 includes an image capture device, e.g., a camera or video camera. Upon the uploader 12 identifying/capturing a content file 24, e.g., a photograph, the GUI 300 may display a text input object 308 that receives a description or text snippet corresponding to the content file 24. In the illustrated example, the user has entered “Scuba diving near the Great Barrier Reef Look at all the fish!!!” In some implementations, the GUI 300 may allow an uploader 12 to upload multiple content files 24 and to provide one or more descriptions 26 for the multiple content files 24. Furthermore, the uploader 12 can relate two or more content files 24, such that the related content files 24 may be displayed/played simultaneously. For instance, the uploader 12 may relate an image file 24a of a beach with an audio file 24c of waves crashing.

Additionally or alternatively, the GUI 300 may include input objects 310 that allow the uploader 12 to tag the content file 24 with a category 312. In the illustrated example, the uploader 12 checked the input object 310a corresponding to the “Travel” category 312a. It is noted that the categories and means by which the category is selected is provided for example only. The GUI 300 may incorporate any other suitable means for providing a category 312 of the content file 24, including but not limited to, a text input Object (e.g., keyword search box), a drop-down menu, or clickable input objects. The GUI 300 may also prompt or allow the uploader 12 to identify a subcategory or attribute of the category 312. In the illustrated example, the GUI 300 includes a drop-down menu 314 that allows the uploader 12 to add the subcategory or attribute of the category selection. In this example, the uploader 12 has specified that the country corresponding to the travel category selection is Australia.

The GUI 300 may further include input objects 316 and/or 318 that allow the uploader 12 to identify one or more sellers 16 to associate with the content file 24. In the illustrated example, the GUI 300 includes a drop down menu 316 that allows the uploader 12 to select a pre-registered seller 16. In this way, the setter 16 may provide one or more resource identifiers 28 corresponding thereto, such that selection of the seller 16 by the uploader 12 from the drop down menu 316 instructs the content upload module 212 to obtain the resource identifier 28 or resource identifiers 28 of the seller 16. Additionally or alternatively, the GUI 300 may include a text input object 318 that allows the uploader 12 to manually enter the resource identifier 28 of a seller 16. Each time an uploader 12 enters a setter 16 or a resource identifier 28 of a seller 16, the GUI 300 may provide new input objects so that the user may associate multiple sellers 16 with the content file 24. In some implementations, the uploader 12 can associate a seller 16 to multiple content files 24.

Once the uploader 12 has entered all the required information, the uploader 12 can select on the “upload” input object 320 to upload the content file data 22. Upon selecting the “upload” input object 320, the user computing device 20 can provide the content file data 22 to the content upload module 2112.

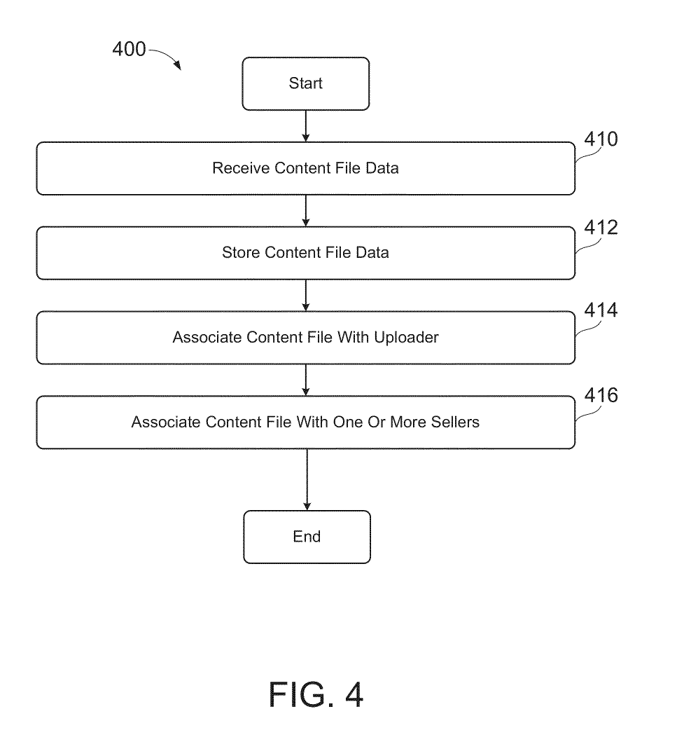

FIG. 4 illustrates an exemplary set of operations for a method 400 of updating the content link datastore 232. It is noted that the method 400 is provided for example only and not intended to limit the scope of the disclosure.

At operation 410, the content upload module 212 receives the content file data 22 from the user computing device 20. As discussed above, the content file data 22 may be provided by an uploader 12 via a GUI 300 displayed at a user computing device 20. The content file data 22 may contain the content file 24, a description 26 of the content file 24 (including a category attic content file), one or more sellers 16 and one or more resource locators 28 of one or more sellers 16. In some implementations, the content upload module 212 may be configured to receive content file data 22 for multiple content files 24. In these implementations, the content files 24 may be related by the uploader 12.

At operation 412, the content upload module 212 stores the content file data 22. In some implementations, the content upload module 212 creates a content record 238a-m. The content upload module 212 can generate a unique identifier to associate with the content file 24. For example, the content upload module 212 can increment a counter each time new content file data 22 is provided, such that the value of the counter is the unique identifier associated with the content file data 22. The content upload module 212 may also include the description and category selection provided by the uploader 12 in the content record 238a-m. The content upload module 212 can store the content record 238a-m in the content link datastore 232.

At operation 414, the content upload module 212 associates the content file 24 with the uploader 12. In some implementations, the content upload module 212 generates a new association record 240a-n. In the new association record 240a-n, the content upload module 212 includes the content file identifier of the new content record 238a-m and the uploader identifier of the uploader 12 in the new association record 240a-n. At operation 416, the content upload module 212 associates the content file data 22 with one or more sellers 16. As previously discussed, the content file data 22 in some implementations identifies one or more sellers 16 and resource identifiers 28 thereof. In these implementations, the content upload module 212 can include the seller indicator of each seller 16 in the association record 240a-n. Further, the content upload module 212 can include one or more resource identifiers 28 for each of the setters 16 identified in the association record 240a-n. In this way, each association record 240a-n indicates a content record 238a-m, a user record 234a-n, and one or more seller records 236a-j. Furthermore, the association record 240a-n may further indicate one or more resource identifiers 28 corresponding to each seller 16.

The method 400 described above is provided for example only. Variations of the method 400 are contemplated and are within the scope of the disclosure.

Referring back to FIG. 2, the search module 214 is configured to receive search criteria from a shopper 14 and to provide content files 24 that the shopper 14 can view and select. For example, the shopper 13 may select a content file 24 or other selectable object associated with the content file 24 to enlarge the content file 24 and/or execute a purchase, after which the shopper 14 is directed to a website 30 of a seller 16. When the shopper 14 selects a content 24 and/or when the shopper 14 completes a purchase on the third party website 30, the search module 214 can update a selection award 38 associated with the uploader 12 of the selected content file 24.

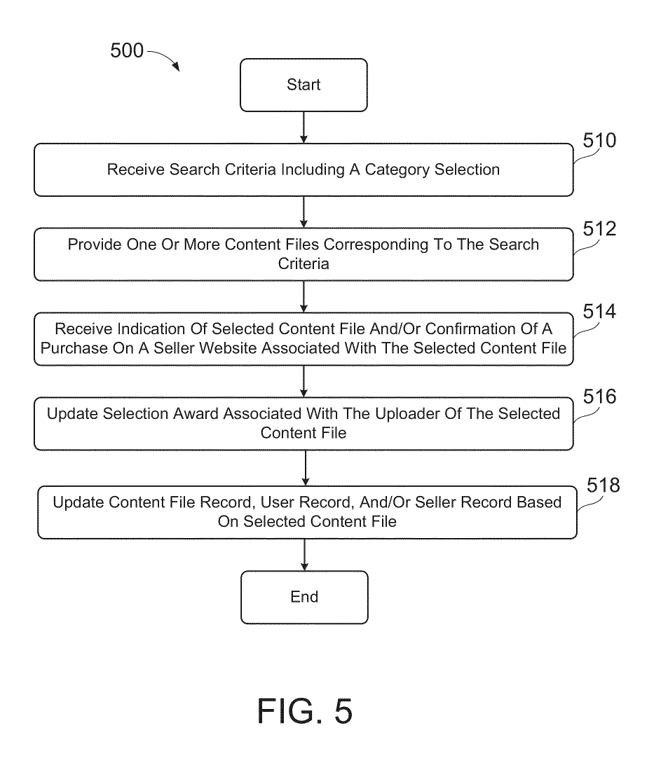

With respect to FIGS. 5-9, FIG. 5 illustrates an example set of operations for a method 500 of facilitating transactions between shoppers 14 and sellers 16. It is noted that the method 500 is provided for example only and not intended to limit the scope of the disclosure.

At operation 510, the search module 214 receives search criteria 602 including a category selection. The search module 214 receives the search criteria 602 from a user computing device 20 of a shopper 14. In some implementations, the search module 214 provides instructions to the user computing device to display a GUI that allows the shopper 14 to request content files 24 by entering a search category 608, and possibly additional search criteria 602.

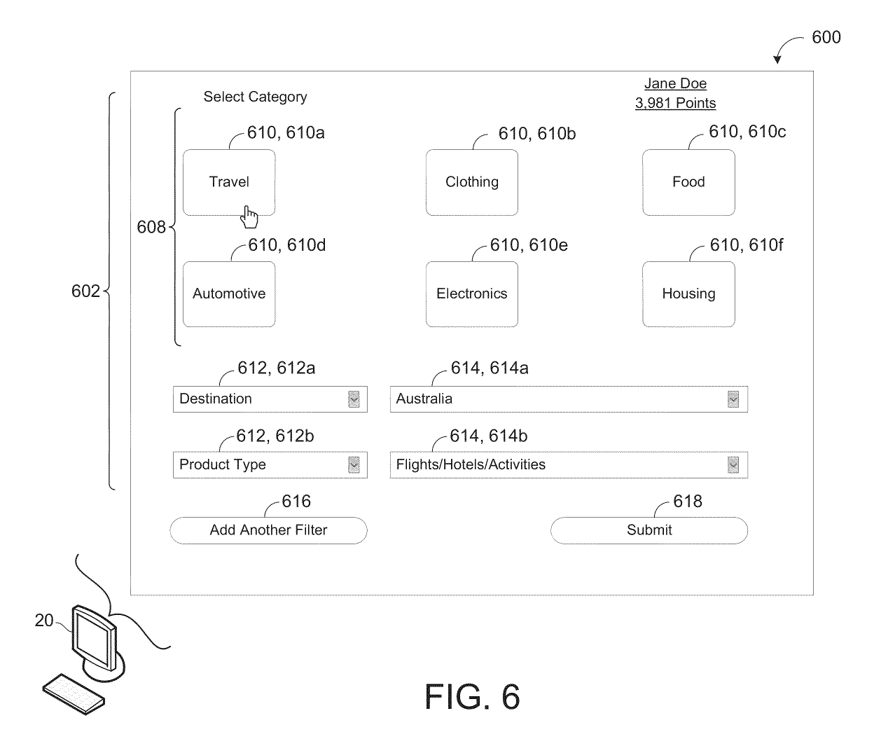

FIG. 6 illustrates an example of a GUI 600 that allows a user to enter search criteria 602. The search criteria may include plain text, text with meta tags, extensible markup language (XML), etc. In the illustrated example, the GUI 600 includes category input objects 610 that allow the user to select a category 608. For example, the user can select a “travel” category input object 610a, a “clothing” category input object 6101), a “food” category input object 610c, an “automotive” category input object 610d, an “electronics” category input object 610e, and a “housing” category input object 610f. In this example, the user has selected the “travel” category input object 610a. The GUI 600 may further allow the user to provide additional search criteria 602. In the illustrated example, the GUI 600 includes drop down menus 612 that allow a shopper 14 to enter a filter type, and drop down menus 614 that allow the shopper 14 to enter a filter corresponding to the filter type. In this example, the shopper 14 has selected the destination type filter 612a and the product type filter 612b. The shopper 14 has also selected Australia 614a as the destination filter and Flights/Hotels/Activities 6146 as the product type filter. The shopper 14 can select the “Add Another Filter” input object 616 to add another filter. In doing so, the shopper 14 can limit the scope of the content files 24 that are returned by the search module 214. It is noted that the GUI 600 may include other means for entering search criteria 602, such as a text input object that allows a shopper 14 to manually enter search terms. The shopper 14 can submit the search criteria to the content link server 200 by selecting the “submit” input object 618. In some examples, some or all of the search criteria is empty (i.e., Null) or the search module 214 returns a record set of content files 24, accordingly (e.g., a result set of a query using received parameters).

At operation 512, the search module 214 provides one or more content files 24 corresponding to the search criteria 602. In response to receiving the search criteria 602, the search module 214 can search the content link datastore 232 using the category selection 604 indicated in the search criteria 602. The content link datastore 232 searches the content records 238a-m using the search category 604. The content link datastore 232 returns content records 238a-m corresponding to the search category 604. The search module 214 can filter the returned content records 238a-m based on the additional criteria 602 provided by the shopper 14. The content link datastore 232 may then obtain the association record 240a-n for each of the identified content records 238a-m. In this way, the search module 214 can identify the sellers 16 that have been associated with each of the content files 24, and ultimately, the resource identifiers 28 for each seller 16. The search module 214 can then transmit each content file 24 and its corresponding description 26 and resource identifiers 28 to the user computing device 20 of the shopper 14, as well as instructions for displaying the content files 24 and the corresponding description 26 and resource identifiers 28.

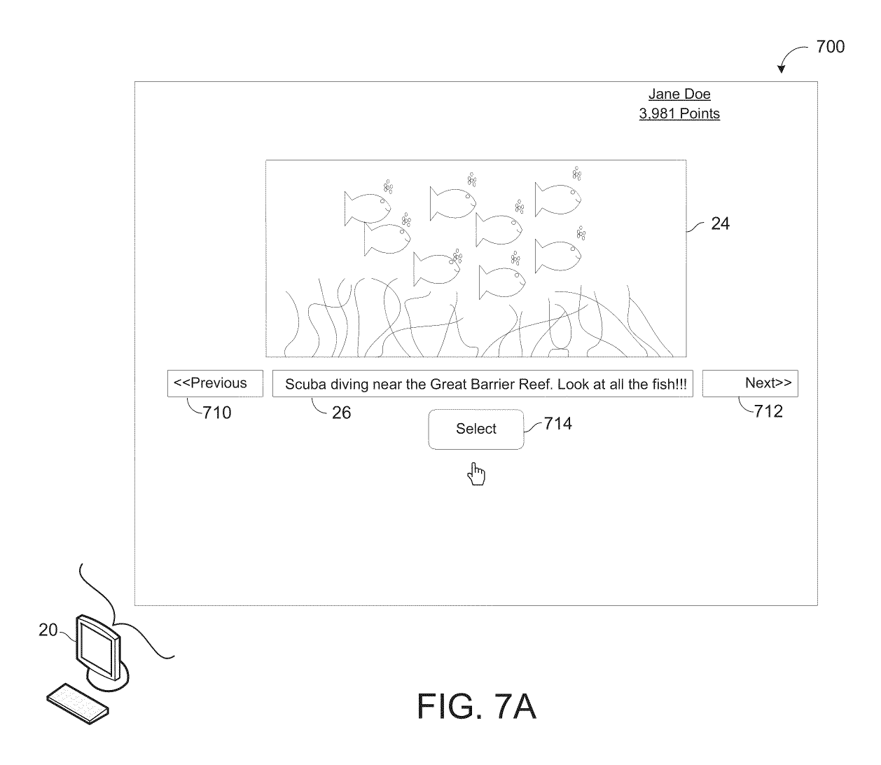

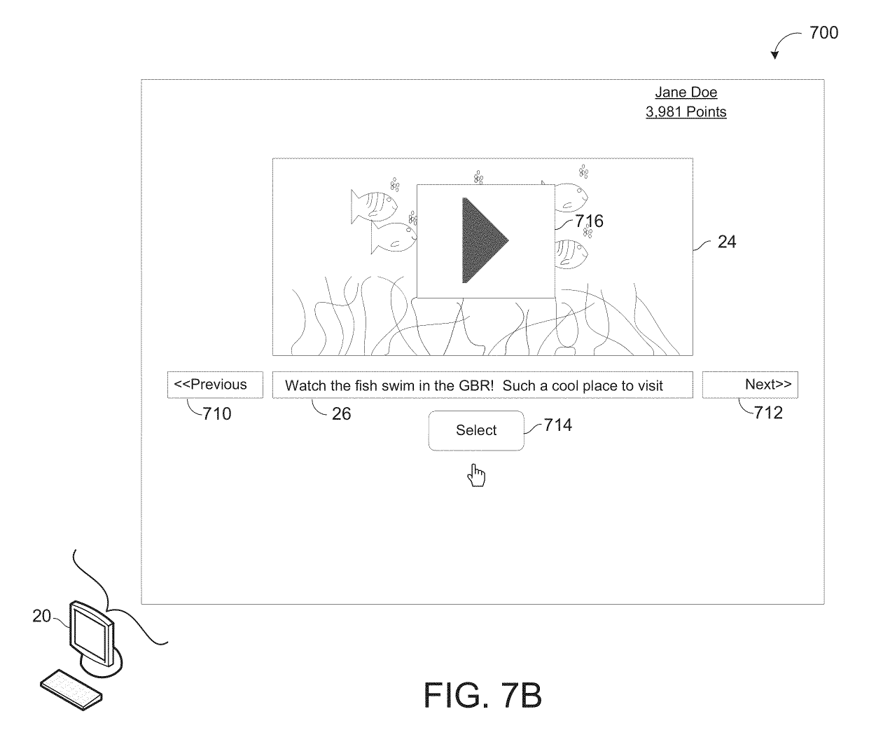

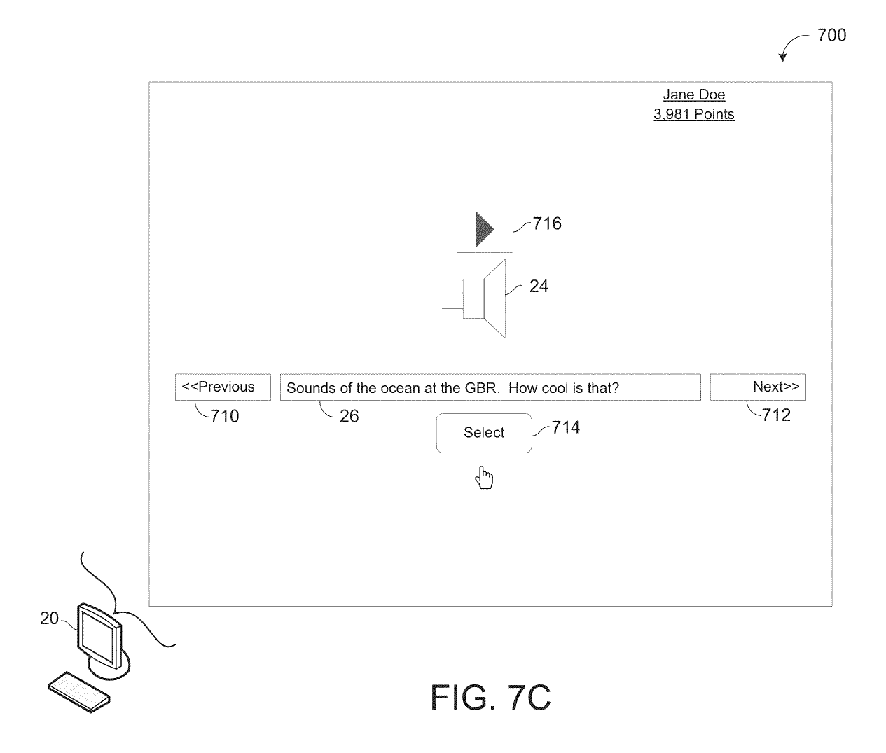

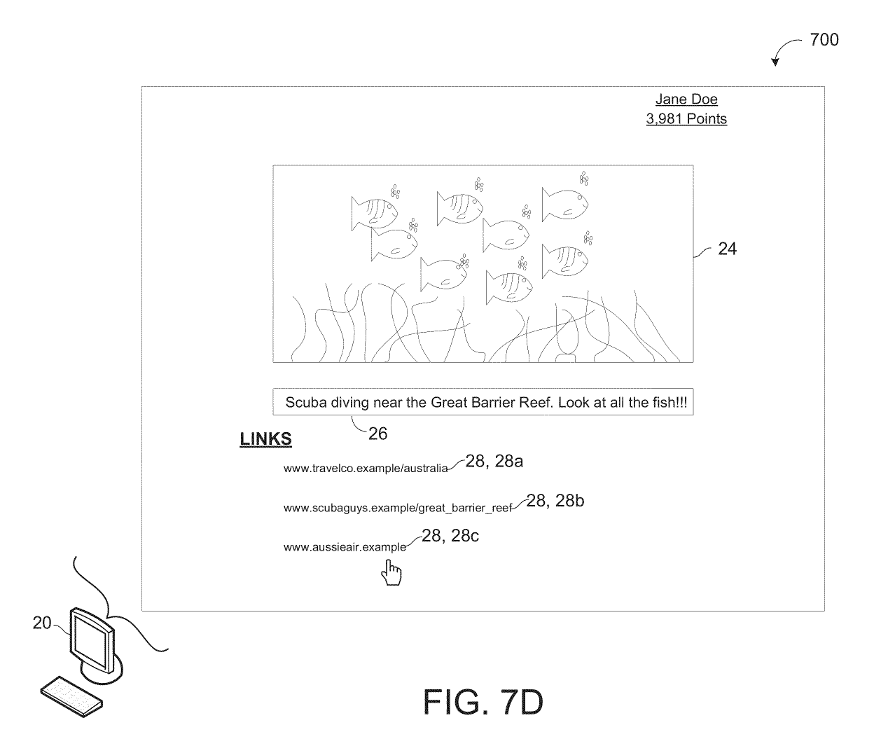

FIGS. 7A-7D illustrate an exemplary GUI 700 that allows a shopper 14 to view and/or listen to content files 24 corresponding to the search criteria provided by the shopper 14 and to select a content file 24. In FIG. 7A, the GUI 700 is displaying a content file 24 containing a photograph, its related description 26, and input objects 710, 712, 714. In the illustrated example, the shopper 14 can view other content files 24 by clicking the previous input object 710 or the next input object 712. By clicking on the previous input object 710 or the next input object 712, the GUI 700 can execute instructions to obtain and display another content file 24 that corresponds to the search criteria 602 and that is not currently displayed by the GUI 700. The GUI 700 may include additional or alternative means for viewing and/or scrolling through the content files 24, such as grid views, tree views, hybrid tree-grid views, etc. For example, the shopper 14 could physically swipe a finger across the screen of the user computing device 20 or can click on the content file 24 and drag it to an edge of the screen to view the next content file 24.

In FIG. 7B, the GUI 700 is displaying a content file 24 containing a video file. The shopper 14 can click on the “play” input object 716 to begin viewing the content file 24. In FIG. 7C, the GUI 700 is displaying a content file 24 containing an audio file. The shopper can click on the content file 24 to begin listening to the content file 24. In the GUIs of 7A, 7B, and 7C, the shopper 14 can select the content file 24 by, for example, clicking on the “select” input object 714 and/or by clicking on the content file 24 itself is noted that the GUI 700 may additionally or alternatively include any other suitable manner for selecting a content file 24, e.g., tapping or voice command.

At operation 514, the search module 214 receives an indication of a selected content file 24 and/or a confirmation of a purchase on a website 30 of a seller 16 associated with the selected content file 24. In some implementations, selection of the content file 24 may automatically direct the web browser of the user computing device 20 to the website 30 of a seller 16 associated with the content file 24. Selecting a content file 24 may cause execution of a pop-up window providing an enlarged view of the content file 24, optionally accompanied with additional content file data 22 or information associated with the content file 24. If, however, more than seller 16 or website 30 has been associated with the content file 24, the GUI 700 may display the resource identifiers 28 of each seller 16 or website 30 for the shopper 14 to select from. In the illustrated example of FIG. 7D, the GUI 700 is displaying a first resource identifier 28a, a second resource identifier 28b, and a third resource identifier 28c. The GUI 700 may display additional information associated with the resource identifiers 28, such as a seller name, price of a shown item, item description, etc. to a facilitate price aggregating. The shopper 14 can select one of the resource identifiers 28 to be redirected to the website 30 of the corresponding seller 16. In response to the user selection, the GUI 700 can communicate an indication 34 of the user selection to the content link server 200. Furthermore, if the shopper 14 eventually makes a purchase from the website 30 of the seller 16, the website 30 of the seller 16 may provide a confirmation 36 of the purchase to the content link server 200. In such a scenario, the seller 16 may have to agree to provide such confirmations 36 to the content link server 200 upon the shopper 14 completing a purchase on the website 30 after being directed to the website 30 by the content link server 200.

At operation 516, the search module 214 updates a selection award 38 corresponding to the uploader 12 of the selected content file 24. A selection award 38 can be any reward that is given or assigned to the uploader 12 (or a party designated by the uploader 12). For example, a selection award 38 may include points that are assigned to an account of the uploader 12 each time a shopper 14 selects one of the uploader's content files 24 and/or each time the search module 214 receives confirmation 36 indicating that a shopper completed a purchase on a website 30 associated with the selected content file 24. Additionally, or alternatively, the selection award 38 may be monetary consideration, such that the uploader 12 is rewarded with a monetary payment each time a shopper selects the uploader's content file 24 and/or when the search module 214 receives confirmation 36 indicating that the shopper 14 completed a purchase on the website 30 associated with the selected content file 24. It is noted that the uploader may elect to have his or her selection award transferred to another party, such as a charity.

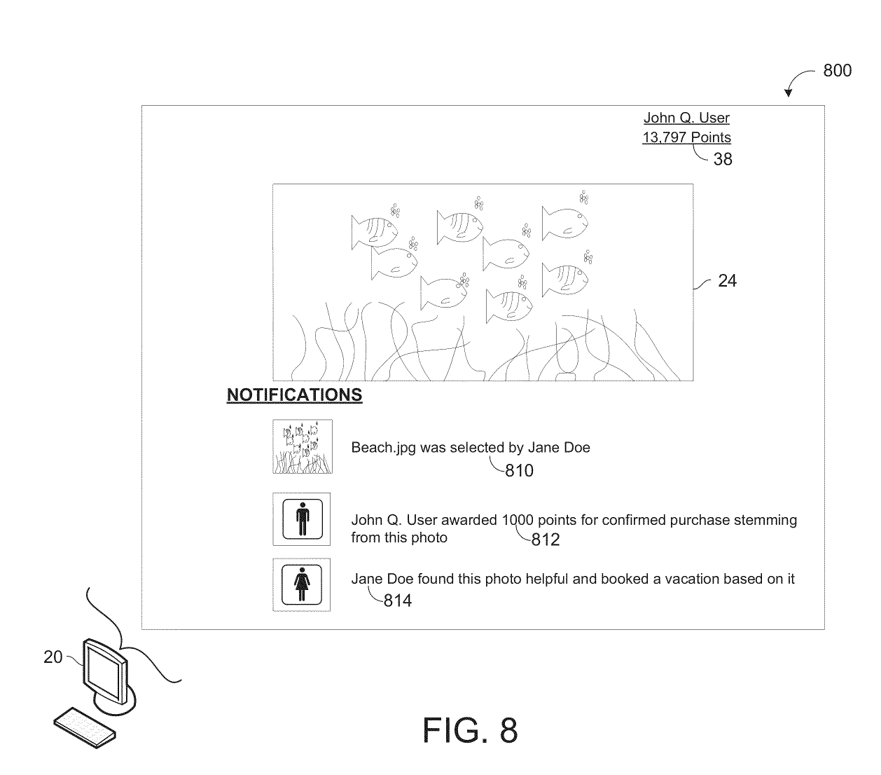

In some implementations, the search module 214 is configured to notify users, e.g., uploaders 12 and/or shoppers 14, when a shopper 14 selects a content file 24 and/or when the search module 214 awards a selection award to an uploader 12. FIG. 8 illustrates an example GUI 800 that notifies a user, e.g., uploader 12 or shopper 14, of an update to a selection award 38. In the example of FIG. 8, the selection award includes points. The GUI 800 may display one or more notifications to a user 12, 14. For example, the GUI 800 may display a first notification 810 indicating which content file 24 was selected, a second notification 812 indicating an amount of points that were awarded to the uploader for the selection, and a third notification 814 indicating the action that was performed by the shopper 14. In this example, the content file 24 “Beach.jpg” was selected by the shopper 14 Jane Doe. In response, the search module 214 awarded the account of the uploader 12 John Q. User 1000 additional points, bringing his point total up to 13,797 points. It is noted that the GUI 800 of FIG. 8 is provided for example only and not intended to limit the scope of the disclosure.

At operation 518, the search module 214 can update a content record 238n, a user record 234n, and/or a seller record 236n based on the selection of the shopper 14, such that the records can be updated to indicate that a shopper 14 selected a content file 24 associated with a seller 16 and updated by an uploader 12. For example, the search module 214 can update the content record 238n of the selected content file 24 (or another record associated therewith) to indicate that it was selected by a shopper 14. Such information may be useful to advertisers and may actually create a monetary demand for the content files 24 that have enjoyed above-average results in directing network traffic to one or more websites. Similarly, if a shopper 14 makes a purchase on a website 30 of a seller 16, the search module 214 can update the purchase history 14 of the shopper 14 in his or her user record 236n.

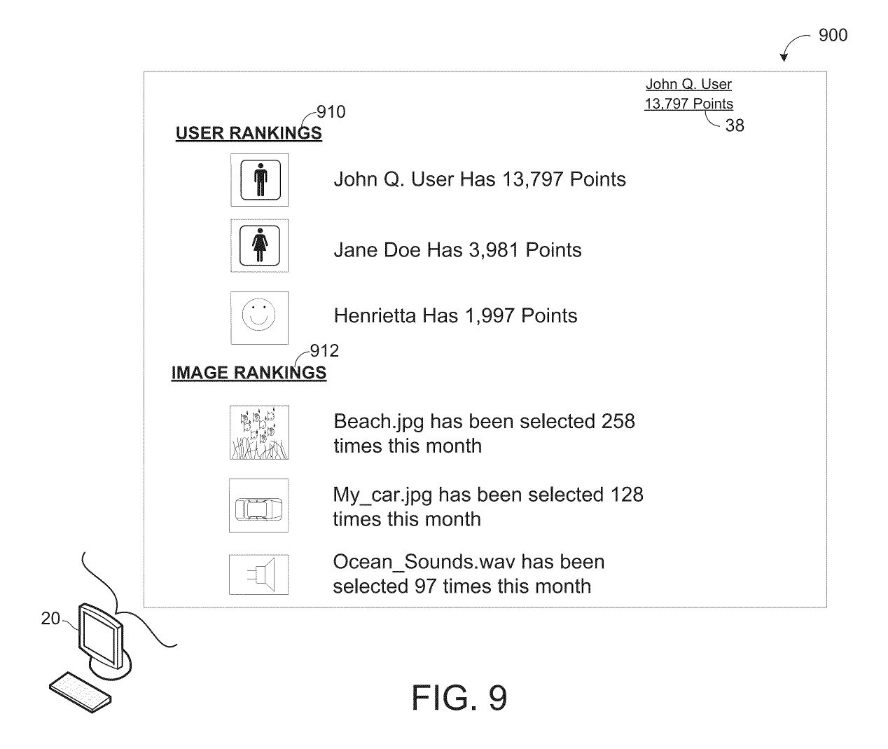

In some implementations, the search module 214 can further rank the uploaders 12 based on each uploader's 12 respective selection award and/or specific content files 24 based on their respective popularity. For example, FIG. 9 illustrates an example GUI 900 for displaying rankings of users according to their respective selection awards and content files 24 based on their respective popularity. In the illustrated example, the user rankings 910 indicate that John Q. User has accumulated the greatest amount of points and the content file rankings indicate that Beach.jpg is the most popular content file 24.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is clamed is:

1. A method comprising:
receiving an uploaded content file at a processing device;
associating, at the processing device, at least one seller of goods or services with the uploaded content file;
electronically providing, from the processing device, one or more content files including the uploaded content file, at least one content file having at least one associated seller;
receiving, at the processing device, an indication of electronic selection of the uploaded content file; and
updating, at the processing device, a selection award associated with the uploaded content file or an uploader of the uploaded content file.

2. The method of claim 1, wherein the uploaded content file comprises at least one of a video file, an image file, or an audio file.

3. The method of claim 1, wherein the uploaded content file is received from a first user computing device corresponding to the uploader, and the indication of electronic selection is received from a second user computing device corresponding to a shopper.

4. The method of claim 3, wherein associating the at least one seller comprises:
receiving, at the processing device, a resource identifier indicating a website of the seller; and
associating, at the processing device, the uploaded content file with the website based on the resource identifier.

5. The method of claim 4, wherein receiving the content file comprises:
receiving, at the processing device, a description corresponding to the content file from the uploader; and
receiving, at the processing device, for each associated seller, an indicator of the seller from the uploader.

6. The method of claim 5, wherein the indicator of the seller is used to look up the resource identifier indicating the website of the seller.

7. The method of claim 4, wherein electronically providing the one or more content files comprises:
receiving, at the processing device, search criteria from a user computing device corresponding to a shopper;
retrieving, at the processing device, the one or more content files including the uploaded content file based on the search criteria, the one or more content files being retrieved from a plurality of content files;
determining, at the processing device, the resource identifier of the uploaded content file based on the association of the uploaded content file with the resource identifier; and
providing, from the processing device, the uploaded content file and the resource identifier.

8. The method of claim 7, wherein each content file of the plurality of content files has corresponding content file data that includes a set of identifying fitter criteria of the shopper.

9. The method of claim 8, wherein retrieving the one or more content files comprises identifying content files from the plurality of content files that have content file data indicating a category corresponding to the category selection included in the search criteria.

10. The method of claim 1, wherein receiving the indication comprises receiving confirmation that a shopper completed a transaction with the seller.

11. The method of claim 1, wherein the selection award comprises monetary or non-monetary consideration.

12. A server comprising:
a non-transitory storage device;
a network interface device; and
a processing device in communication with the storage device and the network interface device, the processing device executing a content upload module and a search module;
wherein the content upload module is configured to:
receive an uploaded content file from a first user computing device corresponding to an uploader; and
associate at least one seller of goods or services with the uploaded content file; and
wherein the search module is configured to:
electronically provide one or more content files including the uploaded content file to a second user computing device of a shopper, at least one content file having at least one associated seller;
receive an indication of electronic selection of the uploaded content file; and
update a selection award associated with the uploaded content file or an uploader of the uploaded content file.

13. The server of claim 12, wherein the content upload module associates the at least one seller with the uploaded content file by:
obtaining a resource identifier indicating a website of the seller; and
associating the uploaded content file with the website based on the resource identifier.

14. The server of claim 13, wherein the content upload module is further configured to:
receive a description corresponding to the content file from the first computing device; and
receive an indicator of the seller from the first computing device.

15. The server of claim 14, wherein the indicator of the seller is used by the search module to look up the resource identifier indicating the website of the seller.

16. The server of claim 13, wherein the search module is configured to electronically provide the one or content files by:
receiving search criteria from the second user computing device;
retrieving the one or more content files including the uploaded content file based on the search criteria, the one or more content files being retrieved from a plurality of content files;
determining the resource identifier of the uploaded content file based on the association of the uploaded content file with the resource identifier; and
providing the uploaded content file and the resource identifier.

17. The server of claim 16, wherein each content file of the plurality of content files has corresponding content file data that includes a set of identifying filter criteria of the shopper.

18. The server of claim 17, wherein the search module is configured to retrieve the one or more content files by identifying content files from the plurality of content files that have content file data indicating a category corresponding to the category selection included in the search criteria.

19. The server of claim 12, wherein the search module is further configured to receive confirmation that the shopper completed a transaction with the seller after selecting the content file.

20. The server of claim 19, wherein the search module updates the selection award upon receiving the confirmation.

21. The server of claim 12, wherein the selection award comprises monetary or non-monetary consideration.

22. The server of claim 12, wherein the selection award comprises points that are awarded to an account of the uploader.
